(19) United States
(12) Patent Application Publication
(10) Pub. No.: US 2010/0189865 A1
(43) Pub. Date: Jul. 29, 2010

(54) POST-FREEZING ACIDIFICATION OF FROZEN DAIRY PRODUCTS

(76) Inventor: Brian Sweet, Minneapolis, MN (US)

Correspondence Address: GENERAL MILLS, INC., P.O. BOX 1113, MINNEAPOLIS, MN, 55440, US

(21) Appl. No.: 12/279,442

(22) PCT Filed: Mar. 1, 2006
(86) PCT No.: PCT/US06/07181

§ 371 Date: Apr. 6, 2010

(51) Int. Cl. A23G 9/04; A23G 9/32

(52) U.S. Cl. 426/565

(57) ABSTRACT

The invention is directed toward a frozen, aerated dairy product, such as an ice cream, having a pH below 6.0 and methods for preparing such products.

### FIELD OF THE INVENTION

The invention relates to production of ice cream and other frozen aerated dairy products having a pH low enough to cause some instability of the milk proteins, especially casein proteins. These low pH frozen dairy products are prepared using fruit acids, such as lemon juice, added after the freezing of the product but before packaging and hardening of the product. The products of the invention have enhanced organoleptic properties, especially when fruit pieces are contained therein.

### BACKGROUND OF THE INVENTION

Frozen aerated dairy products, especially ice cream, have typically been produced at pH of 6.0 or above. At this pH, proteins in the milk, especially casein proteins, have a uniformly negative charge and repel each other thereby staying in relative suspension. However, as the pH of the environment in which casein proteins are suspended begins to drop, the protein molecules begin to lose the net negative charge strength. The casein protein molecules then begin to attract and to curdle. Below pH 5.0, the casein protein micelles begin to rapidly clump together, or coprecipitate.

This curdling and/or or precipitation during production of a frozen aerated dairy product means a substantially increased viscosity in the product. The increased viscosity in turn means that significant increases in energy are required to process and convey the product. The increased viscosity of the product also produces increased wear on production equipment. Moreover, curdled milk solids in this type of product result in an undesirable dry, crumbly mouthfeel for the consumer of the product.

### DESCRIPTION OF RELATED ART

EP 1342418 discloses a method for production of a frozen ice-cream product having a pH of 6.0 or below. In one embodiment, the ice cream product is produced by combining a cream mix having a pH above 6.0 with an acid component, such as a sorbet, just prior to freezing of the ice-cream mixture.

U.S. Ser. No. 10/664,101 discloses a method for production of a frozen aerated product, such as an ice cream, having a pH when melted between 3.5 and 5.2 and containing specified amounts of soluble and insoluble dietary fibers that act as stabilizers. In one embodiment, a pre-mix to which a fruit or vegetable puree has been added is acidified just prior to freezing of the product to achieve the lower pH ranges disclosed in the specification.

Surprisingly, it has been found that addition of relatively small amounts of fruit acids, such as those derived from citrus fruits and more particularly lemon juice, can be added after the initial freezing of the product to reduce the pH of the final product and present a more authentic fruit taste to the final product, especially where fruit or fruit pieces are included in the product.

### SUMMARY OF THE INVENTION

The invention is directed toward a method for preparing a frozen aerated dairy product, that includes the steps of freezing and aerating a mixture comprising MSNF, milk fat, and at least one sweetener, adding a fruit acid to reduce the pH of the frozen, aerated mixture to a desired pH below 6.0, and hardening the frozen aerated dairy product. The mixture may also include an egg component, such as egg yolk or sugared egg yolk. The frozen aerated dairy product may include fruit or fruit pieces. The fruit acid added to the mixture may be obtained from a citrus fruit and may be lemon juice or concentrated lemon juice. Concentrated lemon juice may be added to a level of 0.25% to 2% by weight of the frozen aerated dairy product. The final pH for the product is designed to achieve optimal (e.g. more authentic) fruit taste for fruit or fruit pieces in the product.

The invention is also directed toward a frozen aerated dairy product having a pH below 6.0, the product including a mixture having at least the following ingredients: MSNF, milk fat, at least one sweetener, and at least one egg component The product also includes a fruit acid that is added to the mixture after freezing of the mixture, and the fruit acid added in an amount sufficient to lower the pH of the mixture to a desired pH below 6.0. The frozen aerated dairy product may be an ice cream. The frozen aerated dairy product may also include fruit or fruit pieces. The fruit acid added to the mixture may be derived from a citrus fruit and may be lemon juice or concentrated lemon juice. The final pH for the product is designed to achieve optimal (e.g. more authentic) fruit taste for the fruit or fruit pieces in the product

### DETAILED DESCRIPTION OF THE INVENTION

The invention relates to frozen dairy products, particularly those that are aerated. The frozen aerated dairy product may be an ice cream. It should be noted that various country laws specify levels of ingredients and aeration for frozen dairy products to be called “ice cream”. For example, the United States standard for ice cream set forth in CFR § 58.2825 provides, in part, that ice cream shall contain at least 1.6 pounds of total solids to the gallon, weigh not less than 4.5 pounds to the gallon, and contain not less than 20 percent total milk solids, constituted of not less than 10 percent milkfat. In no case shall the content of milk solids not fat be less than 6 percent. The requirements of other countries may vary. The products of the present invention may be formulated in such a way as to conform to such requirements for manufacture and sale as ice cream.

Preparation of the frozen dairy product entails the steps of creating a raw mix containing a fat component, milk solids not fat (“MSNF”), sweetener, water and optionally egg yolks. The raw mix is then pasteurized and cooled to a temperature of approximately 40° F. Pasteurization of the raw mix may be accomplished in batch or in High Temperature Short Time (“HTST”) protocols known to one skilled in the art. The mix may also be homogenized according to protocols known to one skilled in the art. The pasteurized mix may then be held for a period of time prior to freezing in a holding tank. The pasteurized mix may also be flavored either in the larger holding tank or a smaller tank in which flavors are added prior to the step of freezing the pasteurized mix.

The fat component in the raw mix may be a dairy fat, a non-dairy fat or a mixture of both. When the fat is a dairy fat, it may be introduced to the raw mix in almost any milk fat source including whole milk, cream, butter, or other milkfat containing product. Non-dairy fats that may be included in the product include edible oils or fats, such as a vegetable oil. Specific oils that may be used include coconut oil, palm kernel oil, peanut oil, olive oil, safflower oil, and soybean (soya bean) oil.

The MSNF in the raw mix may contain one or more milk proteins as well as milk sugars, such as lactose. MSNF may be introduced into the mix as a liquid milk product, a dried milk product or as a condensed or otherwise concentrated milk product. MNSF may be added separately from the fat component or together with the fat component such as in a cream or other liquid milk product.

Sweeteners used in the raw mix include, for example, sucrose, fructose, glucose (dextrose) and invert sugar, lactose, lactitol, inulin or a mixture. Sweeteners may be added in either crystalline or liquid syrup form. The frozen dairy product may also contain a corn sweetener in a crystalline form of refined corn sugar (dextrose and fructose), a dried corn syrup (corn syrup solids), a liquid corn syrup or a mixture thereof. For example, a glucose syrup with DE (dextrose equivalent) varying from 20 to 70 may be used as a sweetener.

Egg yolks may also be added to the raw mix. Egg yolks may be added in liquid form and may have been pasteurized prior to addition to the raw mix. Egg yolks in combination with sugar (for example at a 10% or 12% level of sugar) may also be used.

In preparing a frozen dairy product in accordance with the present invention, the pasteurized mix is introduced into a continuous freezer at which time air is also introduced into the product. The product emerges as an aerated, at least partially frozen product and is maintained in this partially frozen condition until hardening as described below. During the freezing process at least 40%, optionally at least 50%, of the water in the pasteurized mix is frozen. The pasteurized mix is aerated by introduction of a gas, such as air, into the mix as the freezing process takes place to achieve an overrun in the frozen aerated mix of 10% to 150%. Those skilled in the art will recognize that such a range is broad and that for the various products that can be made according to the invention, certain classes of products will often be aerated to a specific level such as 100% and for certain premium ice creams the overrun will be much lower (for example, in the ranges of 20%-40% or 20-30% or to a specific value such as 20%, 25% or 30%). Calculation of overrun for the frozen aerated mix may be done by one skilled in the art using known methods and taking into account ingredients that may or may not entrap air.

In one embodiment, a fruit feeder, or similar device, downstream from the freezer is used to introduce a fruit preparation containing fruit such as berries (or pieces thereof) or other fruits (or pieces thereof) into the frozen aerated mix. The fruit preparation may contain water and sweetener in addition to the fruit, fruit pieces or fruit puree. Fruit preparations may contain for example, 20-70% fruit or fruit pieces, 0-70% fruit juice, 0-5% fruit acid and 10-50% sweetener, such as the one or more sugars listed above. The pH of the fruit preparation may be in the range of pH 2.0 to about pH 4.0. However, the pH of the fruit preparation may need to be higher in certain circumstances depending, in part, on the fruit used.

Typically, the fruit or fruit pieces in a fruit preparation will maintain the pH of the fruit preparation after being incorporated into the frozen aerated product. Therefore, care should be taken in formulation of the fruit preparation to ensure that the pH of the fruit preparation does not fall so low that the fruit or fruit pieces take on a sour flavor or other off flavor. The fruit preparation is a vehicle to add these fruit pieces to the ice cream, but it also imparts color, sweetness and acidity to the frozen aerated dairy product. Due at least in part to the limitation of the pH of the fruit preparation, the pH of a frozen aerated dairy product containing a fruit preparation will not be low enough for the fruit or fruit pieces entrained therein to present an authentic fruit taste.

In order to achieve a more authentic fruit taste for the fruit or fruit pieces entrained in the product, the pH of the final product necessary for this authentic fruit taste is achieved by the addition of small amounts of fruit acid (0.10% to 3.0%, optionally 0.5% to 2.0%, based on the final product, and calculated on a percent acid basis) to the frozen aerated product using the fruit feeder, or through separate equipment. The amount added to the product will depend at least in part on the desired sourness of the final product and at least in part on the type of fruit used and the pH of the product required for the desired authentic taste. The fruit acid may be a citrus derived acid such as lemon juice or concentrated lemon juice. The fruit acid may be added to the frozen aerated product prior to or after the addition of the fruit preparation.

In another embodiment, a fruit feeder, or similar device, downstream from the freezer is used to introduce fruit pieces such as berries (or pieces thereof) or other fruits (or pieces thereof) directly into the frozen aerated product. Small amounts of fruit acid (0.10% to 3.0%, optionally 0.5% to 2.0%, based on the final product, and calculated on a percent acid basis) are also introduced into the frozen aerated product using the fruit feeder, a similar device, or using separate equipment to mix in the fruit acid. The fruit acid may be a citrus derived acid such as lemon juice or concentrated lemon juice. The fruit acid is added in amounts to achieve a more authentic taste for the fruit or fruit pieces entrained in the frozen aerated product.

In addition to a fruit feeder, a hopper in communication with a pump or a progressive cavity pump may be used to introduce the fruit preparation into the product. The progressive cavity pump may also be used to introduce the fruit acid. Where the fruit preparation or fruit acid is added upstream from a fruit feeder, the mixer in the fruit feeder may be used to disperse the fruit preparation or fruit acid.

In another embodiment, a fruit feeder, or similar device, downstream from the freezer is used to introduce relatively small amounts (e.g. 0.5% to 25.0%, optionally 1.0% to 5.0%, based on the final product) of low pH fruit puree or puree concentrate, fruit juice or juice concentrate, into the frozen aerated product. In this embodiment, the puree is distributed evenly throughout the product to lower the pH of the product in order to achieve an optimal taste profile. A product made according to this embodiment may contain fruit pieces added directly to the product or a fruit preparation as described above.

The frozen aerated product may then be hardened by cooling to a temperature of −15° F. or below. Prior to hardening the product may be passed through a filler to introduce portions of predetermined size into packages for retail or other sale.

The invention may be further understood by consideration of the following non-limiting examples.

### Example 1

A raw mix containing 30-40% cream, 20-30% condensed skim milk, 1-6% sugared egg yolks, 7-15% sweetener and balance water is blended together. (In this Example, the raw mix accounts for 75-85% of the final product and the percentages of the ingredients disclosed for the raw mix are based on the presence of the ingredient in the final product. Also, sweetener levels are based on solids content where syrups or liquid sweeteners are used.) The mix is homogenized and pasteurized according to methods known to one skilled in the art. The mix is then processed in a continuous freezer and aerated to at least a 20% overrun (optionally 25% overrun) level. Lemon juice concentrate is added to a 0.25 to 2% level to the frozen aerated mix and blended. A fruit preparation (pH 3.1) containing blueberries, blueberry juice, lemon juice concentrate, sugar, and pectin is subsequently added to a 15-25% level and blended into the frozen aerated mix. The product is subsequently hardened by cooling the product to −15° F. The pH of the final product may be in the range of pH 4.8 to pH 5.0 or about pH 4.9. Upon consumption, the flavor of the blueberries contained in the product is found by the consumer to have a more authentic blueberry taste, and the flavor of the ice cream achieves a more authentic taste. The lower product pH may also make the color authentic (more blue-red, less blue-green).

### Example 2

A raw mix containing 30-40% cream, 20-30% condensed skim milk, 1-6% sugared egg yolks, 7-15% sweetener and balance water is blended together. (In this Example, the raw mix accounts for 75-85% of the final product and the percentages of the ingredients disclosed for the raw mix are based on the presence of the ingredient in the final product. Also, sweetener levels are based on solids content where syrups or liquid sweeteners are used.) The mix is homogenized and pasteurized according to methods known to one skilled in the art. An apricot puree is added at a 5-10% level, based on the final product. The mix is then processed in a continuous freezer and aerated to at least a 20% overrun (optionally 25% overrun) level. A fruit preparation containing apricots pieces, apricot juice, lemon juice concentrate, sugar, and pectin is added to a 10-25% level and blended into the frozen mix. Subsequently, lemon juice concentrate is added to an additional 0.25 to 2% level to the frozen aerated mix and blended to produce the frozen dairy product. The product is subsequently hardened by cooling the product to −15° F. The pH of the final product may be in the range of pH 4.7 to pH 4.9 or about pH 4.8. Upon consumption, the flavor of the apricot pieces contained in the product may be found by the consumer to have a more authentic apricot taste, and the surrounding ice cream will also have a more authentic apricot taste.

### Example 3

A raw mix containing 30-40% cream, 20-30% condensed skim milk, 1-6% sugared egg yolks, 7-15% sweetener and balance water is blended together. (In this Example, the raw mix accounts for 85-98% of the final product and the percentages of the ingredients disclosed for the raw mix are based on the presence of the ingredient by weight in the final product. Also, sweetener levels are based on solids content where syrups or liquid sweeteners are used.) The mix is homogenized and pasteurized according to methods known to one skilled in the art. The mix is then processed in a continuous freezer and aerated to at least a 20% overrun (optionally 25% overrun). Subsequently, a passion fruit puree concentrate is added to a 2% to 4% level and the frozen aerated mix is blended to produce the frozen dairy product. The product is subsequently hardened by cooling the product to −15° F. The pH of the final product may be in the range of pH 4.6 to pH 4.8 or about pH 4.7. Upon consumption, the flavor of the passion fruit contained in the product is found by the consumer to have a more authentic taste. In an alternate embodiment, a passion fruit variegate is added to the product a 4% to 12% level after addition and blending in of the puree.

The invention has been described with respect to specific embodiments and ranges. However, one skilled in the art will recognize that variations in ingredients, such as the fruits used in the product, and minor changes in concentrations of ingredients may be made and the resulting products will still be within the scope of the invention.

I claim:

1. A method for preparing a frozen aerated dairy product, comprising the steps of:
freezing and aerating a mixture comprising MSNF, milk fat, and at least one sweetener;
adding a fruit acid to reduce the pH of the frozen, aerated mixture to a desired pH below 6.0; and
hardening the frozen aerated dairy product

2. The method of claim 1, wherein the mixture further comprises an egg component.

3. The method of claim 2, wherein the frozen aerated dairy product further comprises fruit or fruit pieces.

4. The method of claim 3, wherein the fruit acid is obtained from a citrus fruit.

5. The method of claim 4, wherein fruit acid is concentrated lemon juice added to a level of 0.25% to 2% by weight of the frozen aerated dairy product.

6. A frozen aerated dairy product having a pH below 6.0, comprising a mixture comprising MSNF, milk fat, at least one sweetener, and at least one egg component, the product further comprising a fruit acid added to the mixture after freezing of the mixture, the fruit acid added in an amount sufficient to lower the pH of the mixture to a desired pH below 6.0.

7. The frozen aerated dairy product of claim 6, wherein the frozen aerated dairy product is an ice cream.

8. The frozen aerated dairy product of claim 7, wherein the frozen aerated dairy product further comprises fruit or fruit pieces.

9. The frozen aerated dairy product of claim 8, wherein the fruit acid is derived from a citrus fruit.

10. The frozen aerated dairy product of claim 9, wherein the fruit acid is concentrated lemon juice.
